(19) United States
(12) Patent Application Publication
(10) Pub. No.: US 2017/0302649 A1
(43) Pub. Date: Oct. 19, 2017

(54) SYSTEMS AND METHODS FOR SEGMENTING INDUSTRIAL ASSET SERVICES

(71) Applicant: General Electric Company, Schenectady, NY (US)

(72) Inventors: Rashmeet Singh, San Ramon, CA (US); Himagiri Mukkamala, San Ramon, CA (US)

(21) Appl. No.: 15/133,020

(22) Filed: Apr. 19, 2016

(51) Int. Cl. H04L 29/06; G06F 9/44

(52) U.S. Cl. CPC H04L 63/083; G06F 8/70

(57) ABSTRACT

Systems and methods are presented for receiving, at a server computer associated with an industrial asset cloud computing system, a request from a user device for industrial asset application development services, the request including a username and password, and verifying, by the server computer, the username and password. The systems and methods further comprise determining, by the server computer, a user profile based on the username, the user profile comprising at least one of an industry, a region of operation, a negotiated contract term, an identity of the user associated with the username as an individual developer or an enterprise, and a role associated with the user; determining, by the server computer, a subset of a plurality of industrial asset application development services based on the user profile, and sending the subset of the plurality of industrial asset development services to the user device to be displayed on the user device.

### TECHNICAL FIELD

The present disclosure relates generally to a mechanism for segmenting industrial asset services.

### BACKGROUND

Embedded software and connectivity among industrial assets presents an opportunity for businesses to alter and enhance operations, for example in fields of manufacturing, energy, agriculture, or transportation, among others. This connectivity among industrial assets is sometimes referred to as the Industrial Internet of Things (IIoT).

Until now, Industrial Internet applications have existed in siloed, one-off implementations. There are several flaws with this approach. For example, a siloed approach limits opportunities to create economies of scale, and fails to unlock the potential of connecting multiple machines and data around the globe.

### BRIEF DESCRIPTION OF THE DRAWINGS

Various ones of the appended drawings merely illustrate example embodiments of the present disclosure and should not be considered as limiting its scope.

FIG. 1 is a block diagram illustrating an asset management system, according to some example embodiments.

FIG. 2 is a flowchart illustrating aspects of a method for a user to register with an asset cloud computing system, according to some example embodiments.

FIGS. 3A-3F each show an example user interface for displaying development services, according to some example embodiments.

FIG. 4 is a flowchart illustrating aspects of a method for segmenting industrial asset services, according to some example embodiments.

FIG. 5 is a flowchart illustrating aspects of a method for adding a new industrial asset application development service, according to some example embodiments.

FIG. 6 is a block diagram illustrating an example of a software architecture that may be installed on a machine, according to some example embodiments.

FIG. 7 is a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein are configured for managing industrial assets. Information about industrial assets and their use conditions, such as gathered from sensors embedded at or near industrial assets themselves, may be aggregated, analyzed, and processed in software residing locally or remotely from the assets. Applications configured to operate at a local or remote processor may be provided to optimize an industrial asset for operation in a business context. A development platform may be provided to enable end-users to develop their own applications for interfacing with and optimizing industrial assets and relationships between various industrial assets and the cloud. Such end-user-developed applications can operate at the device, fleet, enterprise, or global level by leveraging cloud or distributed computing resources.

The development platform may have a number of services available to an application developer. For example, an application developer may register with the platform and then use the platform to subscribe to various services and to deploy developed applications to an application platform. A service may represent a self-contained endpoint which provides reusable functionality (e.g., a security authentication/authorization application). Communication to and from a service may be made via an application programming interface (API). A service may be accessible across organizations to maximize reuse and minimize overhead. Instances of a given service may reside in individual spaces associated with an application developer. Development services may be developed by the entity or entities hosting the development platform, or by third party developers. An application developer may be an individual or an enterprise.

There may be an incredible number of services that may be provided to application developers. Some services may be relevant across industries, geographic regions, etc., but others may be very specific to an industry, geographic region, subscription contract, etc. Accordingly, systems and methods described herein provide for segmenting industrial asset services based on a user profile, contracted subscription services, geographic regions, among other things, to provide targeted services for a particular application developer. Moreover, systems and methods described herein allow a developer of a service to update pricing in real-time so that when a user views or accesses a service, the user will see the updated pricing.

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate.

Low-level software and hardware-based controllers have been used to drive industrial assets. However, with the rise of inexpensive cloud computing, increasing sensor capabilities, and decreasing sensor costs, as well as the proliferation of mobile technologies, there are new opportunities to enhance the business value of some industrial assets.

While progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance.

In an example, an industrial asset can be outfitted with one or more sensors configured to monitor an asset's operations or conditions. Data from the one or more sensors can be recorded or transmitted to a cloud-based or other remote computing environment. By bringing such data into a cloud-based computing environment, new software applications can be constructed, and new physics-based analytics can be created. Insights gained through analysis of such data can lead to enhanced asset designs, or to enhanced software algorithms for operating the same or similar asset at its edge, that is, at the extremes of its expected or available operating conditions.

In an example, an industrial asset improvement loop can be provided. The improvement loop can include receiving data about one or more assets, such as collected from one or more assets or from sensors appurtenant to the one or more assets. The improvement loop can further include analyzing the collected data locally or at a cloud-based or other remote computing system. Based on the analysis of the data, one or more asset updates can be identified. In an example, an asset update can include a maintenance schedule change, an operating parameter change, or other update based on the analyzed data. The improvement loop can include updating the same one or more assets corresponding to the analyzed data, or can include updating other assets. That is, updates can optionally be pushed to different assets, such as of the same or similar type to the assets from which the analyzed data was received, to yield improvements across multiple assets of the same or similar type.

In an example, the improvement loop includes further collecting data after an update is implemented, such as to monitor one or more effects of the update. In an example, the improvement loop includes monitoring assets that received the update and monitoring one or more assets that did not receive the update. Such a continuous improvement loop can drive productivity in the form of predictive asset maintenance, improved operational performance, or fleet management, among other ways.

The systems and methods for managing industrial assets can include or can be a portion of an Industrial Internet of Things (IIoT). In an example, an IIoT connects industrial assets, such as turbines, jet engines, and locomotives to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets.

In an example, a cloud computing system includes at least one server computer, at least one database, and a plurality of users or assets that are in data communication with the cloud computing system. The cloud computing system can further include or can be coupled with one or more processor circuits or modules configured to perform a specific task, such as to perform tasks related to asset maintenance, analytics, data storage, security, or some other function, as further described herein.

In an example, a manufacturer of industrial assets can be uniquely situated to leverage its understanding of industrial assets themselves, models of such assets, and industrial operations or applications of such assets, to create new value for industrial customers through asset insights. In an example, an asset management platform (AMP) or system can incorporate a manufacturer's asset knowledge with a set of development tools and best practices that enable asset users to bridge gaps between software and operations to enhance capabilities, foster innovation, and ultimately provide economic value.

In an example, an AMP includes a device gateway that is configured to connect multiple industrial assets to a cloud computing system. The device gateway can connect assets of a particular type, source, or vintage, or the device gateway can connect assets of multiple different types, sources, or vintages. In an example, the multiple connected assets can belong to different asset communities (e.g., notional groups of assets that are assigned by the end user and/or by the AMP), and the asset communities can be located remotely or locally to one another. The multiple connected assets can be in use (or non-use) under similar or dissimilar environmental conditions, or can have one or more other common or distinguishing characteristics. In an example, information about environmental or operating conditions of an asset or an asset community can be shared with the AMP. Using the AMP, operational models of one or more assets can be improved and subsequently leveraged to optimize assets in the same community or in a different community.

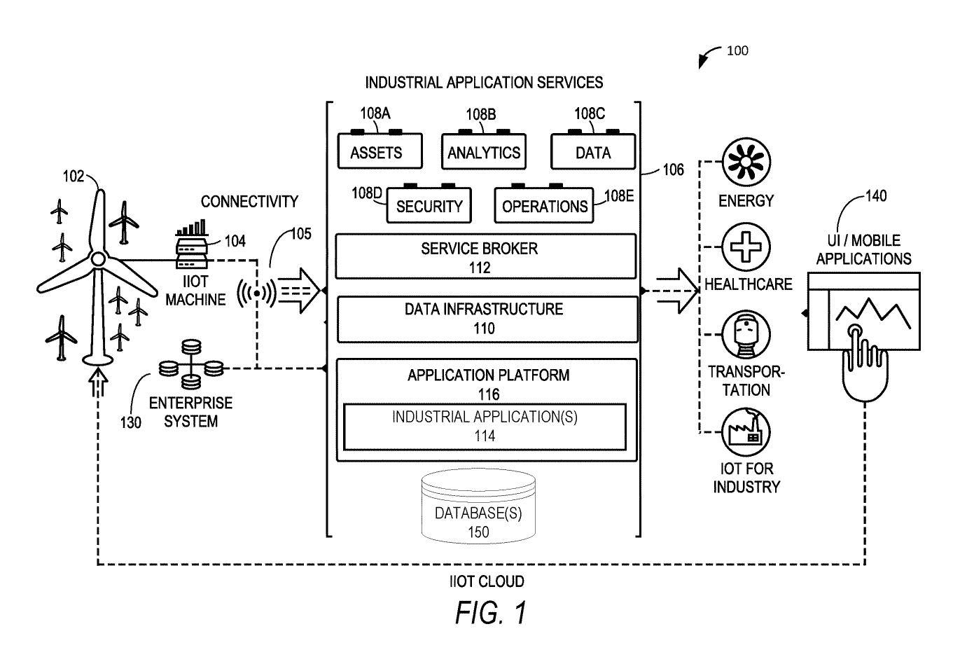

FIG. 1 illustrates an example of portions of an asset management platform (AMP) 100 or system. As further described herein, one or more portions of an AMP 100 can reside in an asset cloud computing system 106, in a local or sandboxed environment, or can be distributed across multiple locations or devices. An AMP 100 can be configured to perform any one or more of data acquisition, data analysis, or data exchange with local or remote assets, or with other task-specific processing devices.

Components and entries of the AMP 100 may communicate over a network, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The AMP 100 includes an asset community 102 that is communicatively coupled with the asset cloud computing system 106. In an example, an IIOT machine 104 receives information from, or senses information about, at least one asset member of the asset community 102, and configures the received information for exchange with the asset cloud computing system 106. In an example, the IIOT machine 104 is coupled with the asset cloud computing system 106 or with an enterprise computing system 130 via a communication gateway 105. In an example, the communication gateway 105 includes or uses a wired or wireless communication channel that extends at least from the IIOT machine 104 to the asset cloud computing system 106.

The example of FIG. 1 includes the asset community 102 with multiple wind turbine assets. Wind turbines are used in some examples herein as non-limiting examples of a type of industrial asset that can be a part of, or in data communication with, the AMP 100.

In an example, the multiple turbine members of the asset community 102 include assets from different manufacturers or vintages. The multiple turbine members of the asset community 102 may belong to one or more different asset communities, and the asset communities may be located locally or remotely from one another. For example, the members of the asset community 102 can be co-located on a single wind farm, or the members can be geographically distributed across multiple different farms. In an example, the multiple turbine members of the asset community 102 can be in use (or non-use) under similar or dissimilar environmental conditions, or can have one or more other common or distinguishing characteristics.

FIG. 1 further includes the communication gateway 105 configured to couple the asset community 102 with an asset cloud computing system 106. The communication gateway 105 may further couple the asset cloud computing system 106 with one or more other assets or asset communities, to an enterprise computing system 130, or to one or more other devices. The AMP 100 thus represents a scalable industrial solution that extends from a physical or virtual asset (e.g., a wind turbine in asset community 102) to a remote asset cloud computing system 106. The asset cloud computing system 106 optionally includes a local, system, enterprise, or global computing infrastructure that can be optimized for industrial data workloads, secure data communication, and compliance with regulatory requirements.

In an example, information from an asset, about the asset, or sensed by an asset itself may be communicated from the asset to the data acquisition module 108C in the asset cloud computing system 106. In an example, an external sensor may be used to sense information about a function of an asset, or to sense information about an environment condition at or near an asset. The external sensor may be configured for data communication with the communication gateway 105 and the data acquisition module 108C, and the asset cloud computing system 106 may be configured to use the sensor information in its analysis of one or more assets, such as using the analytics module 108B.

In an example, the AMP 100 may use the asset cloud computing system 106 to retrieve an operational model for a wind turbine, such as using the assets module 108A. The model may be stored locally in the asset cloud computing system 106, or the model may be stored at the enterprise computing system 130, or the model may be stored elsewhere. The asset cloud computing system 106 may use the analytics module 108B to apply information received about the wind turbine or its operating conditions (e.g., received via the communication gateway 105) to or with the retrieved operational model. Using a result from the analytics module 108B, the operational model may optionally be updated, such as for subsequent use in optimizing the wind turbine or one or more other assets, such as one or more assets in the same or different asset community. For example, information about the wind turbine may be analyzed at the asset cloud computing system 106 to inform selection of an operating parameter for a remotely located second wind turbine that belongs to a different asset community.

The IIOT machine 104 may include a software layer configured for communication with one or more industrial assets and the asset cloud computing system 106. In an example, the IIOT machine 104 may be configured to run an application locally at an asset, such as at a wind turbine. The IIOT machine 104 may be configured for use with or installed on gateways, industrial controllers, sensors, and other components. In an example, the IIOT machine 104 may include a hardware circuit with a processor that is configured to execute software instructions to receive information about an asset, optionally process or apply the received information, and then selectively transmit the same or different information to the asset cloud computing system 106.

In an example, an AMP 100 may be configured to aid in optimizing operations or preparing or executing predictive maintenance for industrial assets. An AMP 100 may leverage multiple platform components to predict problem conditions and conduct preventative maintenance, thereby reducing unplanned downtimes. In an example, the IIOT machine 104 may be configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit may apply analytics or algorithms at the IIOT machine 104 or at the asset cloud computing system 106.

In response to the detected error conditions, the AMP 100 may issue various mitigating commands to the asset, such as via the IIOT machine 104, for manual or automatic implementation at the asset. In an example, the AMP 100 may provide a shut-down command to the asset in response to a detected error condition. Shutting down an asset before an error condition becomes fatal can help to mitigate potential losses or to reduce damage to the asset or its surroundings. In addition to such an edge-level application, the IIOT machine 104 may communicate asset information to the asset cloud computing system 106.

In an example, the asset cloud computing system 106 may store or retrieve operational data for multiple similar assets. Over time, data scientists or machine learning may identify patterns and, based on the patterns, may create improved physics-based analytical models for identifying or mitigating issues at a particular asset or asset type. The improved analytics can be pushed back to all or a subset of the assets, such as via multiple respective IIOT machines 104, to effectively and efficiently improve performance of designated (e.g., similarly-situated) assets.

FIG. 1 further includes an interface device 140. The interface device 140 may be configured for data communication with one or more of the IIOT machine 104, the gateway 105, or the asset cloud computing system 106. The interface device 140 may comprise, but is not limited to, a mobile phone, desktop computer, laptop, computer console, portable digital assistants (PDAs), smart phones, tablets, ultra books, netbooks, laptops, multi-processor systems, microprocessor-based or programmable consumer electronics, or any other communication device that a user may utilize to access the AMP 100. In some embodiments, the interface device 140 comprises a display module (not shown) to display information (e.g., in the form of user interfaces). In further embodiments, the interface device 140 comprises one or more of touch screens, accelerometers, gyroscopes, cameras, microphones, global positioning system (GPS) devices, and so forth.

The interface device 140 may be used to monitor or control one or more assets. In an example, information about the asset community 102 may be presented to an operator at the interface device 140. The information about the asset community 102 may include information from the IIOT machine 104, or the information may include information from the asset cloud computing system 106. In an example, the information from the asset cloud computing system 106 includes information about the asset community 102 in the context of multiple other similar or dissimilar assets, and the interface device 140 can include options for optimizing one or more members of the asset community 102 based on analytics performed at the asset cloud computing system 106. Moreover, the interface device 140 may access and utilize one or more industrial applications 114 hosted by the application platform 116.

In an example, an operator may select a parameter update for a particular industrial asset, such as one of the wind turbines in example asset community 102, using the interface device 140, and the parameter update is pushed to the wind turbine via one or more of the asset cloud computing system 106, the gateway 105, and the IIOT machine 104. In an example, the interface device 140 is in data communication with the enterprise computing system 130, and the interface device 140 provides an operation with enterprise-wide data about the first asset community 102 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 140, the asset cloud computing system 106, the enterprise computing system 130, or elsewhere.

The asset cloud computing system 106 may include various industrial application services and related components. These services and components may be hosted on one or more server computers and may utilize one or more databases 150 for storing various data related to industrial assets, industrial applications, users accessing and utilizing the asset cloud computing system 106, etc. For example, the asset cloud computing system 106 may provide services for applications designed by developers, such as asset services from assets module 108A, analytics services from analytics module 108B, data services from data module 108C, application security services from security module 108D, and operational services from operations module 108E. Moreover, the asset cloud computing system 106 may include a data infrastructure 110.

Asset services provided by assets module 108A may include services to create, import, and organize asset models and their associated business rules.

The asset model may be the centerpiece of many, if not all, Industrial Internet applications. While assets are the instantiations of asset types (types of industrial equipment, such as turbines), the asset model is a digital representation of the asset's structure. In an example embodiment, the assets module 108A provides Application Program Interfaces (APIs), such as Representational State Transfer (REST) APIs that enable application developers to create and store asset models that define asset properties, as well as relationships between assets and other modeling elements. Application developers can then leverage the service to store asset-instance data. For example, an application developer can create an asset model that describes the logical component structure of all turbines in a wind farm and then create instances of that model to represent each individual turbine. Developers can also create custom modeling objects to meet their own unique domain needs.

In an example embodiment, the assets module 108A includes an API layer, a query engine, and a graph database. The API layer acts to translate data for storage and query in the graph database. The query engine enables developers to use a standardized language, such as Graph Expression Language (GEL), to retrieve data about any object or property of any object in the asset service data store. The graph database stores the data.

An asset model represents the information that application developers store about assets, how assets are organized, and how they are related. Application developers can use the assets module 108A APIs to define a consistent asset model and a hierarchical structure for the data. Each piece of physical equipment may then be represented by an asset instance. Assets can be organized by classification and by any number of custom modeling objects. For example, an organization can use a location object to store data about where its pumps are manufactured, and then use a manufacturer object to store data about specific pump suppliers. It can also use several classifications of pumps to define pump types, assign multiple attributes, such as Brass or Steel, to each classification, and associate multiple meters, such as Flow or Pressure, to a classification.

Data services provided by data module 108C may include services to ingest, clean, merge, and ultimately store data in the appropriate storage technology so that it can be made available to applications in the manner most suitable to their use case. Data services from the data module 108C enable Industrial Internet application developers to bring data into the asset cloud computing system 106 and make it available for their applications. This data may be ingested via an ingestion pipeline that allows for the data to be cleansed, merged with data from other data sources, and stored in the appropriate type of data store, whether it be a time series data store for sensor data, a Binary Large Object (BLOB) store for medical images, or a relational database management system (RDBMS).

Since many of the assets are industrial in nature, much of the data that will commonly be brought into the AMP 100 for analysis is sensor data from industrial assets. In an example embodiment, a time series service may provide a query efficient columnar storage format optimized for time series data. As the continuous stream of information flows from sensors and needs to be analyzed based on the time aspect, the arrival time of each stream can be maintained and indexed in this storage format for faster queries. The time series service also may provide the ability to efficiently ingest massive amounts of data based on extensible data models. The time series service capabilities address operational challenges posed by the volume, velocity, and variety of IIoT data, such as efficient storage of time series data, indexing of data for quick retrieval, high availability, horizontal scalability, and data point precision.

Analytics services provided by analytics module 108B may include services to create, catalog, and orchestrate analytics that will serve as the basis for applications to create insights about industrial assets.

Application security services provided by security module 108D may include services to meet end-to-end security requirements, including those related to authentication and authorization. The application security services provided by the security module 108D include user account and authentication (UAA) and access control. The UAA service provides a mechanism for applications to authenticate users by setting up a UAA zone. An application developer can bind the application to the UAA service and then use services such as basic login and logout support for the application, without needing to recode these services for each application. Access control may be provided as a policy-drive authorization service that enables applications to create access restrictions to resources based on a number of criteria.

Operational services provided by operations module 108E may enable application developers to manage the lifecycle and commercialization of their applications. The operational services may include services that developers can use to build or test Industrial Internet applications, or services to implement Industrial Internet applications, such as in coordination with one or more other AMP modules. In an example, the operations services may include a microservices marketplace where developers can publish their services and/or retrieve services from third parties. The operations services may include a development framework for communicating with various available services or modules. The development framework can offer developers a consistent look and feel and a contextual user experience in web or mobile applications.

Operational services may include development operational services, which are services to develop and deploy Industrial Internet applications in the cloud, and business operational services, which are services that enable transparency in the usage of Industrial Internet applications so that developers can ensure profitability.

The development services may provide developers with tools to create and run industrial applications in the asset cloud computing system 106. In an example, the development services include tools to facilitate building, testing, and deploying new tools. In an example, the development services may include various features for facilitating automation. Tools for source control management, agile planning, automated build and deploy, or testing can be helpful for efficiently moving code through the pipeline from development to production.

In an example, the development services may include source control management (SCM). For example, a hosted SCM system may be made available for storing application source code. Developers may move existing project code or create a new project by using portions of example applications already on the platform.

In an example, the development services may include a continuous delivery (CD) pipeline that can be configured to automate software builds, tests, and deployments. The CD pipeline may be configured to ensure predictability from the beginning of the development cycle through production delivery. It checks that build processes are working, and enables rapid and repeatable provisioning of new environments. With these CD tools, application developers may create a pipeline with automated build, test, and deploy capabilities to shorten the time-to-value for customers.

The business services may include various features that help providers add value for customers. With cloud computing, the software provider may be also the software operator, and may instrument its code to better understand the usage of the software. That is, the software provider can embed various code features that ultimately help the software operator (in this case, the same entity as the software provider) to identify which portion(s) of the software are most often used and in what manner.

In an example, the business services include a web-based monetization solution that enables continuous business model innovation for industrial services. By giving product and marketing managers granular control and visibility over how key components are rolled out, tested, and scaled within a particular business model, the business services can provide tools (e.g., product catalog, packaging, pricing and policies) to ensure profitability. Product and marketing teams can iteratively build, split-test, and launch each component to one or more customers and distribution channels. As business models get rolled out and scaled, the product and marketing teams can have visibility into their revenue and cost metrics so they can measure the impact of the changes. Additionally, they gain insight into the best and worst performing products, packages, customer segments, and distribution channels.

The asset cloud computing system 106 may further include a service broker 112. The service broker 112 may provide application developer access to the provided industrial application services. For example, the service broker 112 may provide registration and management of an application developer account and subscription services. The service broker 112 may comprise one or more server computers and may utilize one or more databases 150

The asset cloud computing system 106 may further include an application platform 116 which may comprise one or more industrial applications 114 created by one or more application developers. The one or more industrial applications may run on the cloud computing system 106 and be hosted by the application platform 116. For example, the application platform 116 may comprise one or more server computers and may utilize one or more databases 150.

Application developers wishing to create Industrial Internet applications for use in the IIoT may wish to use common services that many such industrial applications may use, such as a log-in page, time series management, data storage, and the like. The way a developer can utilize such services is by instantiating instances of the services and then having their applications consume those instances. Typically, many services may be so instantiated.

To use common services provided by the asset cloud computing system 106, an application developer may register with the asset cloud computing system 106 and subscribe to the services that he wishes to use to develop one or more industrial applications.

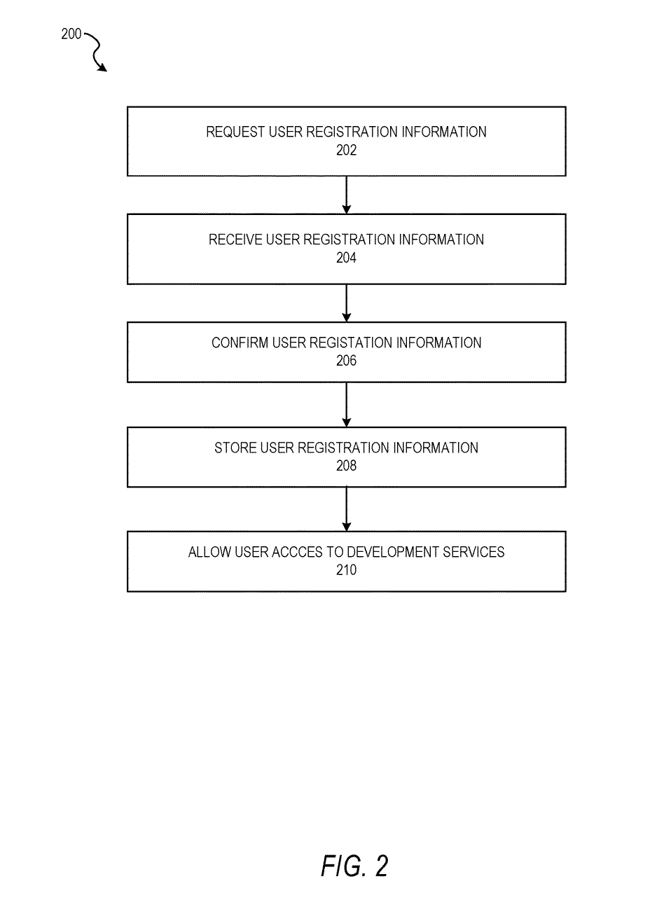

FIG. 2 is a flow chart illustrating aspects of a method 200 for a user (e.g., application developer) to register with an asset cloud computing system 106, according to some example embodiments. For illustrative purposes, method 200 is described with respect to the AMP 100 of FIG. 1. It is to be understood that method 200 may be practiced with other system configurations in other embodiments.

An application developer may register with the asset cloud computing system 106 via a web portal, an application, a command line tool, or other interface or method, using a device such as interface device 140. In operation 202, the system 106 (e.g., via service broker 112) may request user information for registration. For example, the service broker 112 may cause an interface to display to the user on the interface device 140 to allow the user to input registration information. Registration information may contain, for example, a name of the user (e.g., first name and last name), an email address, a company name, an industry, a phone number, the region where the application developer is located and/or where the application will be deployed/made accessible, a password, billing information, etc. The user may then submit the registration information to the service broker 112.

At operation 204, the service broker 112 receives the user registration information, and at operation 206, may confirm the user registration information (e.g., determine that the information is valid, determine there is no missing information, determine there is not already an account for the user, etc.). The service broker 112 stores the user registration information at operation 208. For example, the service broker 112 may store the user registration information in one or more databases 150.

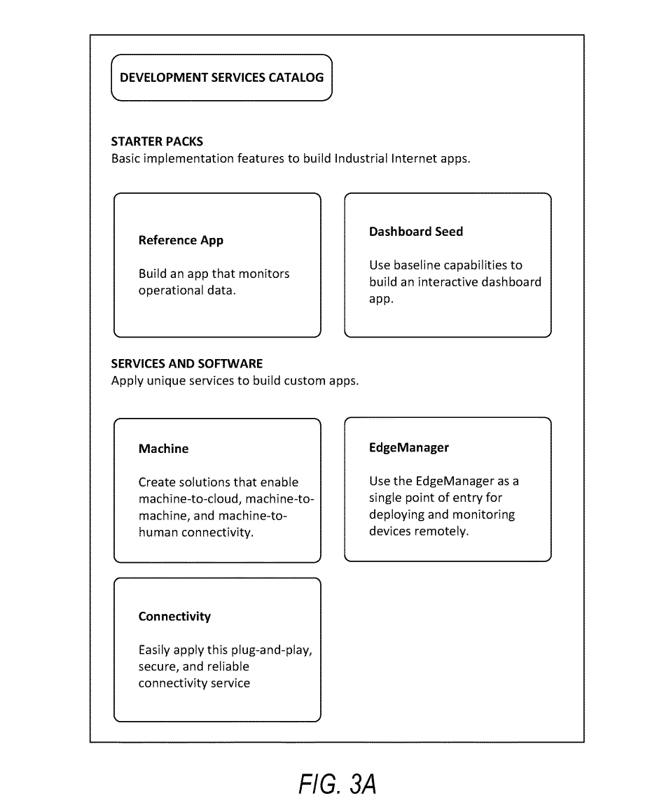

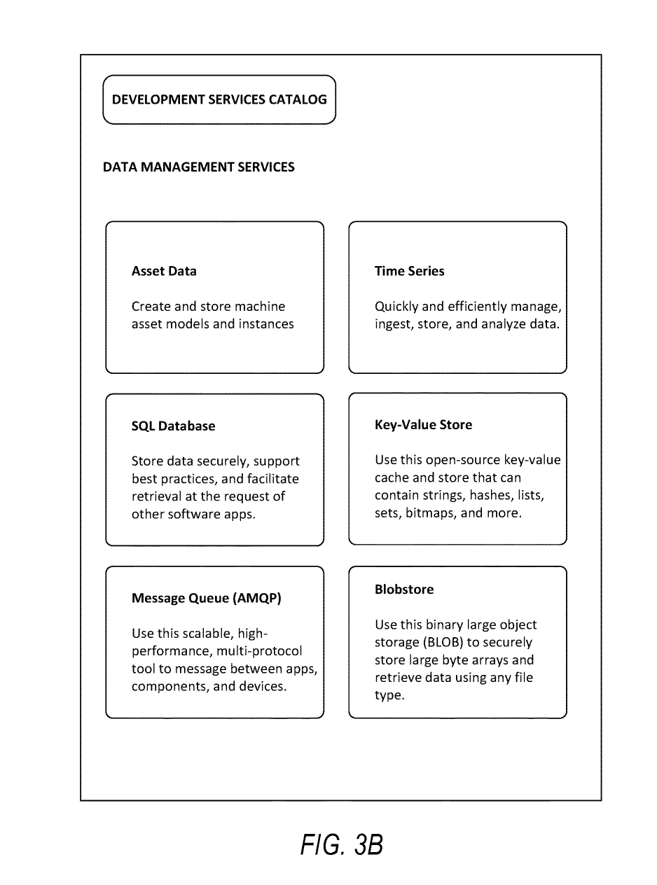

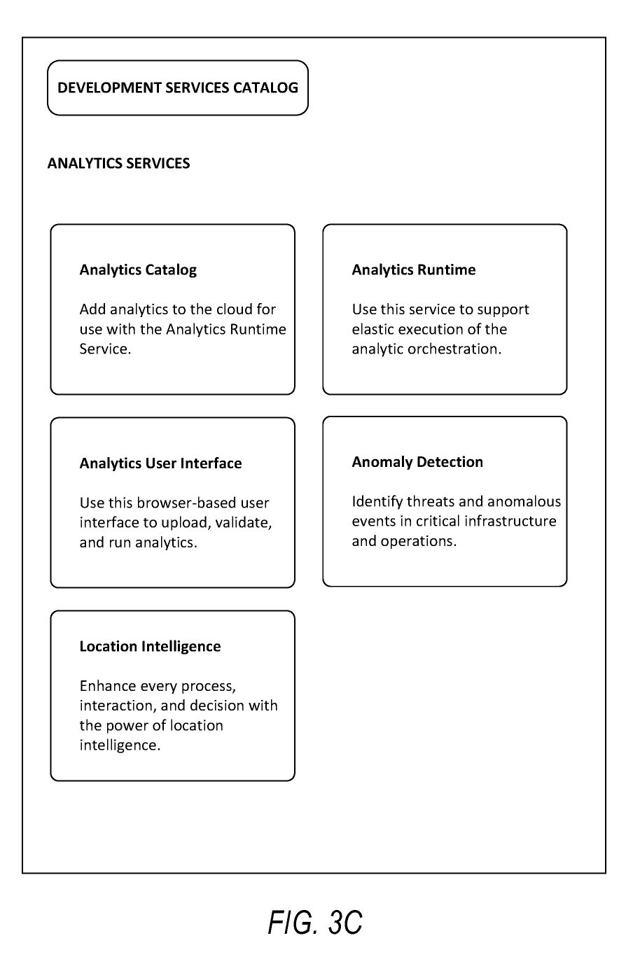

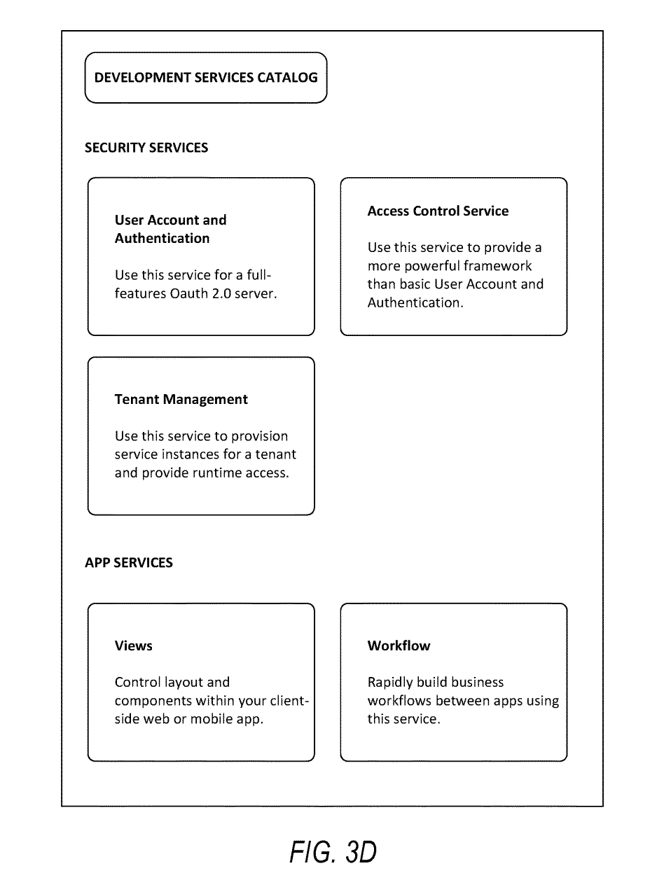

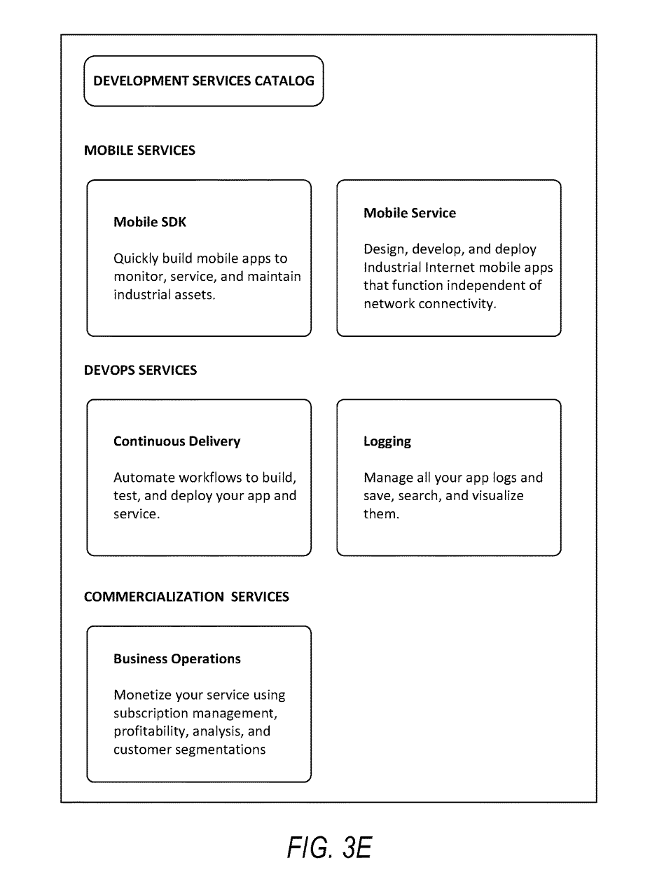

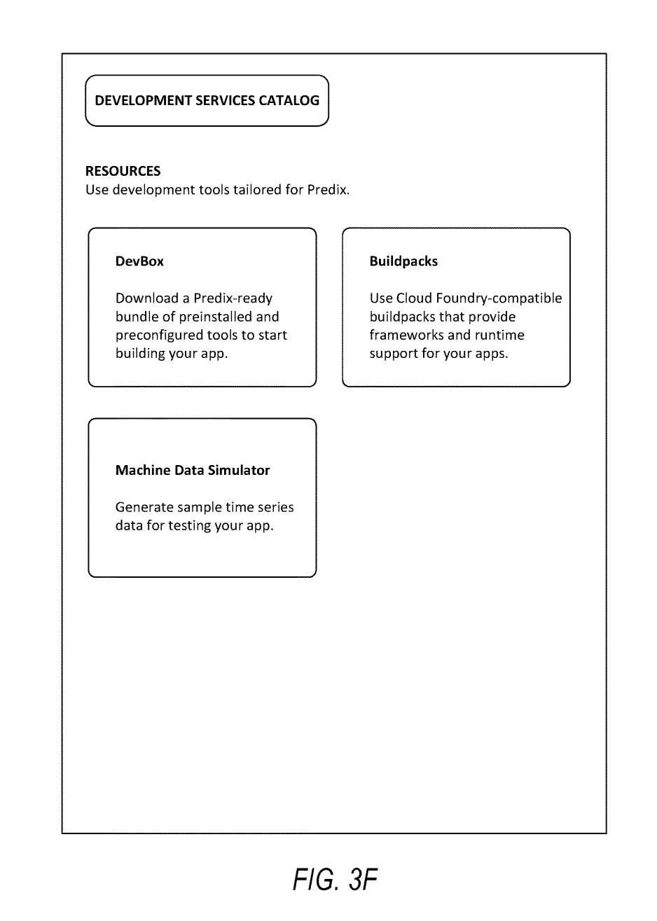

Once a user is registered with the system 106, the user may have access to any number of development services. In operation 210 the service broker 112 allows user access to the development services. For example, the service broker 112 may cause an interface to display to the user on the interface device 140 to allow the user to view and access various services as shown in FIGS. 3A-3F.

As discussed above, there may be an incredible number of services that may be provided to application developers. Some services may be relevant across industries, geographic regions, etc., but others may be very specific to an industry, geographic region, subscription contract, etc. Accordingly, systems and methods described herein relate to systems and methods for segmenting industrial asset services based on a user profile, contracted subscription services, geographic regions, among other things, to provide targeted services for a particular application developer.

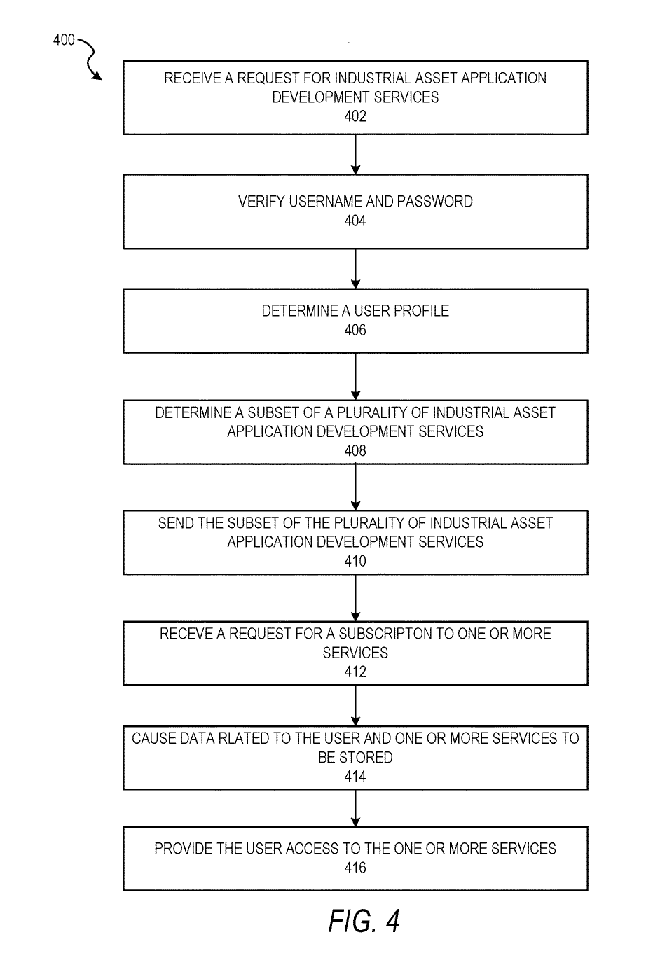

FIG. 4 is a flow chart illustrating aspects of a method 400 for segmenting industrial asset services, according to some example embodiments. For illustrative purposes, method 400 is described with respect to the AMP 100 of FIG. 1. It is to be understood that method 400 may be practiced with other system configurations in other embodiments.

In operation 402, a server computer associated with the asset cloud computing system 106 (e.g., via service broker 112) receives a request from a user device for industrial asset application development services. The request may include a username, password, etc. The server computer may verify the username and password at operation 404. For example, the server computer may check that the username exists in the system 106 (e.g., is stored in one or more databases 150) and confirm the password corresponds to the username, is correct, etc. The username and password may be associated with a user. The user may be an application developer of an industrial internet application for managing one or more industrial assets.

In operation 406, the server computer determines a user profile. In one example, the server computer may determine the user profile based on a user name. The user profile may include at least one of an industry, a region of operation, a negotiated contract term, an identity of the user associated with the username as an individual developer or an enterprise, and a role associated with the user. An example of an industry may be energy (e.g., wind, electric, gas, etc.), healthcare, transportation (e.g., aviation), etc. A region of operation may be a geographic location where the user operates a business, where the user may deploy an Industrial Internet application, where the user is logging in from, etc.

A negotiated contract term may include a plan to which the individual developer or enterprise has subscribed, specific pricing that was negotiated for services, etc. For example, an enterprise may have a certain price for a certain number of plans or services and different prices may be available to an individual developer. A user may be an individual developer or part of an enterprise. In one example, the asset cloud computing system 106 may provide different services, prices, terms, etc. for an enterprise versus an individual developer.

A role associated with the user may include a particular title or field of the user, such as a data scientist.

In operation 408, the server computer determines a subset of a plurality of industrial asset application development services based on the user profile. For example, the server computer may analyze service plan data of each of the plurality of industrial asset application development services to determine which industrial asset application development services are relevant to the user profile.

In one example, the server computer may determine a region in which the user plans to deploy an Industrial Internet application for managing one or more industrial assets based on the region of operation, and determine the subset of the plurality of industrial asset application development services based on the industrial asset application development services that are available in the region in which the user plans to deploy the Industrial Internet application. The server computer may further determine pricing for each of the subset of the industrial asset application development services based on the region in which the user plans to deploy the Industrial Internet application.

In another example, the server computer may determine a region in which the user is physically located or where the user plans to deploy an Industrial Internet application to determine which industrial application development services apply to that region. For instance, some services may only be available in one region (e.g., the U.S.) while others may only be available in other regions (e.g., China). Or, some services may only be available in certain states in the U.S., or on the East Coast or West Coast, etc. Moreover, a geographic region associated with a user profile may also determine in which language or currency to display the information about the industrial application development services.

In another example, the server computer may determine a service plan and a negotiated price according to the service plan based on the negotiated contract term, and determine the subset of the plurality of industrial asset application development services based on the service plan and the negotiated price. The server computer may further determine pricing of each of the subset of the industrial asset application development services based on the service plan and the negotiated price.

In yet another example, the server computer may determine a user role to determine which industrial application development services may be relevant to that role. For example, if the user is a data scientist, more analytical-type services may be relevant to a data scientist. Or, if a user has a particular role in the aviation industry, certain services may be more applicable to the aviation industry and for that particular user role in that industry. The user may also provide his own content in the form of services and/or analytics to be included in the plurality of service.

In another example, the server computer may determine which industrial application development services may be relevant to a particular industry. For example, if the industry is aviation or wind turbines, the server computer may determine which industrial application development services are most relevant to those particular industries.

In another example, the server computer may determine which industrial application development services may be relevant to an individual developer versus an enterprise developer. For instance, an individual developer may be interested in less complex plans while an enterprise developer may need more diversity of services from which to choose. Or different pricing may apply to an individual developer versus an enterprise developer as described above. Or different pricing may be negotiated for different enterprises.

To determine a user profile and various aspects of a user profile, the server computer may utilize one or more databases 150 to determine profile information and/or utilize external databases. For example, it may use registration information from the user, information on what services to which the user has already subscribed, any negotiated contract terms, etc. These may all be stored in internal or external databases (e.g., customer relationship management (CRM), BizOps, registration, etc.)

In operation 410, the server computer sends the subset of the plurality of industrial asset development services to be displayed on the user device. For example, the user may see a list of industrial asset development services as shown in FIGS. 3A-3F.

A user may subscribe to one or more of the plurality of industrial asset development services to utilize in Industrial Internet application development. To subscribe, a user may indicate which servicer or services to which he would like to subscribe (e.g., selecting the service(s) via a user interface, etc.). The user may send a request for the one or more services, to a server computer associated with asset cloud computing system 106 (e.g., via service broker 112).

At operation 412 the server computer receives a request for a subscription to one or more services of the subset of the plurality of industrial asset services. In operation 414, the server computer causes data related to the user and the one or more services to be stored (e.g., in one or more databases 150, external databases, etc.). The server computer may provide the user access to the one or more services, as shown in operation 416. The user may then begin utilizing those services.

As described above, a developer may develop and deploy an industrial application via an application platform. In addition, a developer may develop industrial asset application development services for other developers to use to develop industrial applications. The industrial asset application development service may become one of the plurality of industrial asset application development services provided via a service broker 112 or other means of the asset cloud computing system 106.

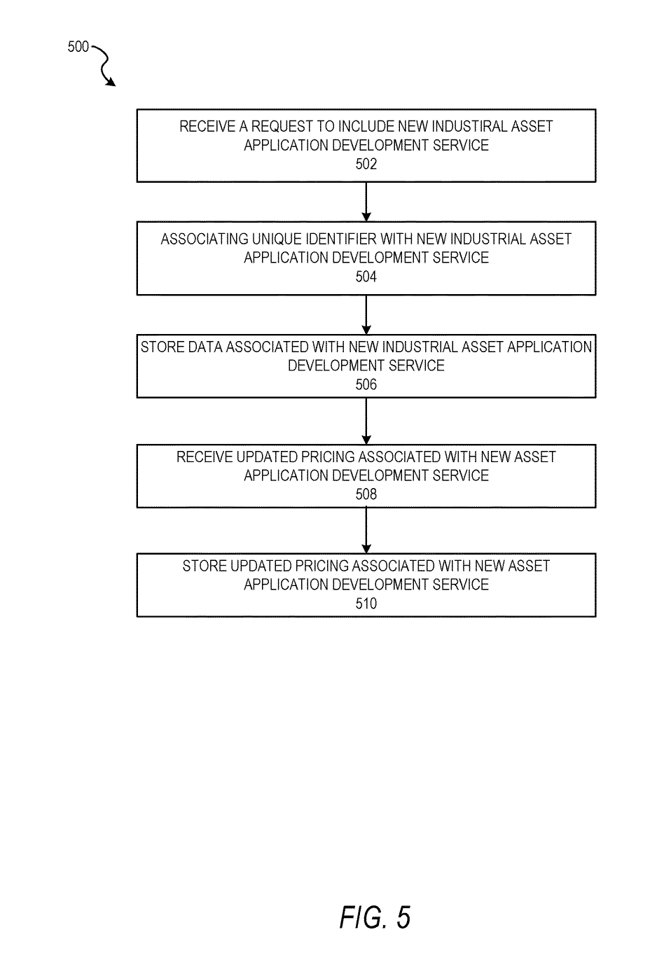

FIG. 5 is a flow chart illustrating aspects of a method 500 for adding a new industrial asset application development service, according to some example embodiments. For illustrative purposes, method 500 is described with respect to the AMP 100 of FIG. 1. It is to be understood that method 500 may be practiced with other system configurations in other embodiments.

Once the developer has developed the industrial asset application development service, he may add the application to the plurality of industrial asset application development services by sending a request to a server computer associated with the asset cloud computing system 106 (e.g., application platform 116, service broker 112, etc.). In operation 502, the server computer receives a request to include a new industrial asset application development service to the plurality of industrial asset applications services. The request may include data associated with the new industrial asset application development service. Such data may include a name of the new service, a description of the new service, one or more industries associated with the new service, one or more regions of operation for the new service, the entity (e.g., individual developer, enterprise, company, etc.) associated with the new service, a username associated with the request, pricing related to the new service, etc.

The server computer may confirm that the request is valid (e.g., determine the request is from a valid user and/or device, determine that the request is for a valid service, etc.). At operation 504, the server computer generates and associates a unique identifier with the new industrial asset application development service. At operation 506, the server computer stores data associated with the new industrial asset application development service including pricing related to the new industrial asset application development service (including the new unique identifier).

A developer, owner, operator (e.g., BizOps manager) etc., of an industrial asset application development service may set or update pricing related to the industrial asset application development service. For example, the developer may be able to dynamically change or update pricing in real time (or substantially real time). In turn, the asset cloud computing system 106 may reflect the pricing change or update in real time (or substantially real time).

For example, a developer may send a changed or updated pricing for the new industrial asset application development service to the asset cloud computing system 106 as a request to update pricing. The request may include a unique identifier associated with the new industrial asset application development service. At operation 508, the server computer receives the updated pricing. At operation 510, the server computer may store the updated pricing associated with the new asset development service, such that the pricing is available real-time (or substantially real-time) next time a user accesses pricing related to the new industrial asset application development service.

In an alternative embodiment, the changed or updated pricing may be for only certain instances, regions, customer, etc. of the new industrial asset application development service. For example, an industrial asset application development service may have different pricing plans, levels, types, etc. In one example there may be one pricing for an individual developer, and another pricing for an enterprise. In another example, there may be different pricing based on the region in which the user, developer, enterprise, etc. operates or plans to deploy an industrial application. In yet another example, there may be different negotiated contract pricing for the new industrial asset application development service for a particular developer, enterprise, etc. In another example, there may be different pricing plans depending on features (e.g., a base plan with base features, a mid plan with additional features, and a high-end plan with all available features, etc.). Some example features may include a number of assets, number of classes, storage, policies evaluations, number of users, support, etc. There may be different ways pricing may work (e.g., per usage, number of instances of a service, etc.).

Accordingly, each industrial asset application development service may have different pricing associated with the industrial asset application development service. These may be stored using separate unique identifiers for each pricing plan. For example, one unique identifier may be used for a first pricing for an enterprise account, another unique identifier may be used for a second pricing for an individual developer, another unique identifier may be used for a third pricing for a particular region or one or more regions, another unique identifier may be used for fourth pricing based on a negotiated contract for a particular customer/entity, etc.

Thus, the server computer may create a new unique identifier for the new pricing if it is for a feature, plan, etc. of the service that has not yet been established, and may associate the new unique identifier with the updated pricing. When a user registers or logs in to view the industrial asset application development services, he will see the service with the pricing that is relevant to him. For example, if the user is an individual developer, he will see the pricing for individual developers. In another example, if the user is an enterprise with a particular negotiated contract price, he will see the pricing based on the negotiated contract price. The user may also see different levels of pricing based on different levels of plans, etc.

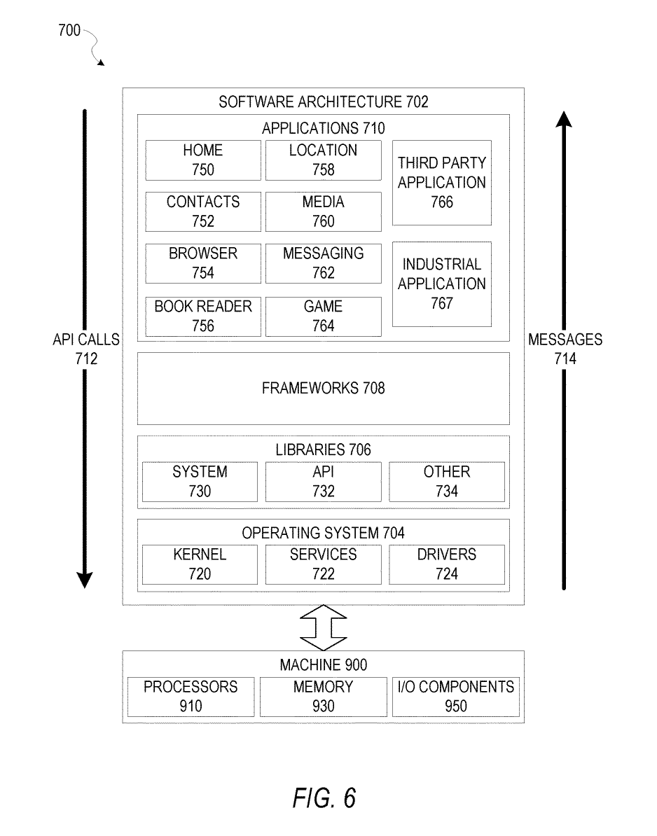

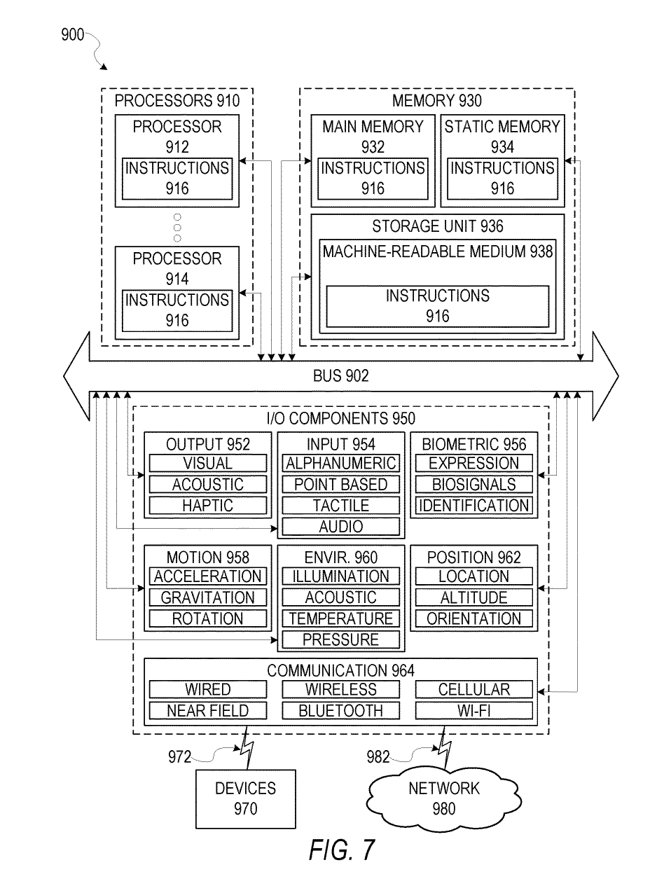

FIG. 6 is a block diagram 700 illustrating a software architecture 702, which can be installed on any one or more of the devices described above. For example, in various embodiments, IIOT machine 104, interface device 140, and servers associated with 108A-108E, 110, 112, 114, 116 120, 122, 124, 128, and 130, may be implemented using some or all of the elements of software architecture 702. FIG. 6 is merely a non-limiting example of a software architecture 702, and it will be appreciated that many other architectures can be implemented to facilitate the functionality described herein. In various embodiments, the software architecture 702 is implemented by hardware such as machine 900 of FIG. 7 that includes processors 910, memory 930, and I/O components 950. In this example, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in graphic content on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications such as a third party applications 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 766 can invoke the API calls 712 provided by the operating system 704 to facilitate functionality described herein.

Some embodiments may include one or more Industrial Internet applications 767. In certain embodiments, this may be a stand-alone application that operates to manage communications with a server system such as the asset cloud computing system 106. In other embodiments, this functionality may be integrated with another application such. Industrial Internet application 767 may request and display various data related to industrial assets and options for configuring and interacting with industrial assets, and may provide the capability for a user to input data related to industrial assets via a touch interface, keyboard, or using a camera device of machine 900, communication with a server system via I/O components 950, and receipt and storage of job configuration data in memory 930. Presentation of industrial asset information and user inputs associated with industrial assets may be managed by Industrial Internet application 767 using different frameworks 708, library 706 elements, or operating system 704 elements operating on a machine 900.

FIG. 7 is a block diagram illustrating components of a machine 900, according to some embodiments, able to read instructions from a machine-readable medium (e.g., a machine-readable storage medium) and perform any one or more of the methodologies discussed herein. Specifically, FIG. 7 shows a diagrammatic representation of the machine 900 in the example form of a computer system, within which instructions 916 (e.g., software, a program, an application 710, an applet, an app, or other executable code) for causing the machine 900 to perform any one or more of the methodologies discussed herein can be executed. In alternative embodiments, the machine 900 operates as a standalone device or can be coupled (e.g., networked) to other machines. In a networked deployment, the machine 900 may operate in the capacity of a server machine or client device in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term “processor” is intended to include multi-core processors 910 that may comprise two or more independent processors 912, 914 (also referred to as “cores”) that can execute instructions 916 contemporaneously. Although FIG. 7 shows multiple processors 910, the machine 900 may include a single processor 910 with a single core, a single processor 910 with multiple cores (e.g., a multi-core processor 910), multiple processors 912, 914 with a single core, multiple processors 910, 912 with multiples cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 include output components 952 and input components 954. The output components 952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 950 include biometric components 956, motion components 958, environmental components 960, or position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or another suitable device to interface with the network 980. In further examples, communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (in other words, not having any transitory signals) in that it does not embody a propagating signal. However, labeling the machine-readable medium 938 “non-transitory” should not be construed to mean that the medium is incapable of movement; the medium 938 should be considered as being transportable from one physical location to another. Additionally, since the machine-readable medium 938 is tangible, the medium 938 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a server computer associated with an industrial asset cloud computing system, a request from a user device for industrial asset application development services, the request including a username and password;
verifying, by the server computer, the username and password;
determining, by the server computer, a user profile based on the username, the user profile comprising at least one of an industry, a region of operation, a negotiated contract term, an identity of the user associated with the username as an individual developer or an enterprise, and a role associated with the user;
determining, by the server computer, a subset of a plurality of industrial asset application development services based on the user profile; and
sending the subset of the plurality of industrial asset application development services to the user device to be displayed on the user device.

2. The method of claim 1, wherein determining the subset of the plurality of industrial asset application development services based on the user profile further comprises:
determining a region in which the user plans to deploy an Industrial Internet application for managing one or more industrial assets based on the region of operation; and
analyzing service plan data of each of the plurality of industrial asset application development services to determine the subset of the plurality of industrial asset application development services based on the industrial asset application development services that are available in the region in which the user plans to deploy the Industrial Internet application.

3. The method of claim 2, further comprising:
analyzing service plan data to determine pricing of each of the subset of the industrial asset application development services based on the region in which the user plans to deploy the Industrial Internet application.

4. The method of claim 1, wherein determining the subset of the plurality of industrial asset application development services based on the user profile further comprises:
analyzing service plan data to determine a service plan and a negotiated price according to the service plan based on the negotiated contract term; and
determining the subset of the plurality of industrial asset application development services based on the service plan and the negotiated price.

5. The method of claim 4, further comprising:
determining pricing of each of the subset of the industrial asset application development services based on the service plan and the negotiated price.

6. The method of claim 1, wherein the user is an application developer of an Industrial Internet application for managing one or more industrial assets.

7. The method of claim 1, further comprising:
receiving a request for a subscription to one or more services of the subset of the plurality of industrial asset application development services;
causing data related to the user and the one or more services to be stored; and
providing the user access to the one or more services.

8. The method of claim 1, further comprising:
receiving a request to include a new industrial asset application development service in the plurality of industrial asset application development services; and
storing data associated with the new industrial asset application development service including pricing related to the new industrial asset application development service.

9. The method of claim 8, further comprising:
receiving an updated pricing related to the new industrial asset application development service; and
storing the updated pricing, such that the updated pricing is available real-time the next time a user accesses pricing related to the new industrial asset application development service.

10. The method of claim 9, wherein the data associated with the new industrial asset application development service includes a unique identifier associated with the new industrial asset application development service, and the method further comprises:
creating a new unique identifier for the new industrial asset application development service; and
associating the new unique identifier with the updated pricing.

11. The method of claim 1, wherein the user profile comprises an industry, a region of operation, a negotiated contract term, an identity of the user associated with the username as an individual developer or an enterprise, and a role associated with the user.

12. A server computer comprising:
one or more processors; and
a computer readable medium coupled with the one or more processors, the computer readable medium comprising instructions stored thereon that are executable by the one or more processors to cause a computing device to:
verify a username and password;
determine a user profile based on the username, the user profile comprising at least one of an industry, a region of operation, a negotiated contract term, an identity of the user associated with the username as an individual developer or an enterprise, and a role associated with the user;
determine a subset of a plurality of industrial asset application development services based on the user profile; and
send the subset of the plurality of industrial asset application development services to a user device to be displayed on the user device.

13. The server computer of claim 12, wherein determining the subset of the plurality of industrial asset application development services based on the user profile further comprises:
determining a region in which the user plans to deploy an Industrial Internet application for managing one or more industrial assets based on the region of operation; and
determining the subset of the plurality of industrial asset application development services based on the industrial asset application development services that are available in the region in which the user plans to deploy the Industrial Internet application.

14. The server computer of claim 13, wherein the instructions that are executable by the one or more processors further cause the computing device to:
determine pricing of each of the subset of the industrial asset application development services based on the region in which the user plans to deploy the Industrial Internet application.

15. The server computer of claim 12, wherein determining the subset of the plurality of industrial asset application development services based on the user profile further comprises:
determining a service plan and a negotiated price according to the service plan based on the negotiated contract term; and
determining the subset of the plurality of industrial asset application development services based on the service plan and the negotiated price.

16. The server computer of claim 15, wherein the instructions that are executable by the one or more processors further cause the computing device to:
determine pricing of each of the subset of the industrial asset application development services based on the service plan and the negotiated price.

17. The server computer of claim 12, wherein the instructions that are executable by the one or more processors further cause the computing device to:
receive a request for a subscription to one or more services of the subset of the plurality of industrial asset application development services;
cause data related to the user and the one or more services to be stored; and
provide the user access to the one or more services.

18. The server computer of claim 12, wherein the instructions that are executable by the one or more processors further cause the computing device to:
receive a request to include a new industrial asset application development service in the plurality of industrial asset application development services;
store data associated with the new industrial asset application development service including pricing related to the new industrial asset application development service;
receive an updated pricing related to the new industrial asset application development service; and
store the updated pricing, such that the updated pricing is available real-time the next time a user accesses pricing related to the new industrial asset application development service.

19. The server computer of claim 18, wherein the data associated with the new industrial asset application development service includes a unique identifier associated with the new industrial asset application development service, and wherein the instructions that are executable by the one or more processors further cause the computing device to:
create a new unique identifier for the new industrial asset application development service; and
associate the new unique identifier with the updated pricing.

20. A non-transitory computer readable medium comprising instructions stored thereon that are executable by one or more processors to cause a computing device to:
verify a username and password;
determine a user profile based on the username, the user profile comprising at least one of an industry, a region of operation, a negotiated contract term, an identity of the a user associated with the username as an individual developer or an enterprise, and a role associated with the user;
determine a subset of a plurality of industrial asset application development services based on the user profile; and
send the subset of the plurality of industrial asset development services to a user device to be displayed on the user device.
